(19) United States
(12) Patent Application Publication
(10) Pub. No.: US 2010/0041325 A1
(43) Pub. Date: Feb. 18, 2010

(54) COIN PROCESSING METHOD AND COIN PROCESSING UNIT

(75) Inventor: Masato Takeuchi, Himeji-shi (JP)

Correspondence Address: DARBY & DARBY P.C., P.O. BOX 770, Church Street Station, New York, NY, 10008-0770, US

(73) Assignee: Glory Ltd., Himeji-shi (JP)

(21) Appl. No.: 12/530,979

(22) PCT Filed: Mar. 24, 2008
(86) PCT No.: PCT/JP2008/055358

§ 371 Date: Sep. 11, 2009

(30) Foreign Application Priority Data
Mar. 27, 2007 (JP) 2007-080556

(51) Int. Cl. G07D 3/00; G07D 9/00

(52) U.S. Cl. 453/3

(57) ABSTRACT

Coins in an escrow unit and a holding and feeding unit can be collectively returned without increasing the size of a coin processing unit. Stopping positions of the escrow unit are set to an escrow position “a” where the coins sent from the transport path are received, an ejection position “b” where the coins dropped and released from the holding and feeding unit are received, a returning position “c” where the escrowed coins are dropped to a returning box, and a storing position “d” where the escrowed coins are dropped to the coin cassette. The escrow unit is moved to the ejection position “b”, then the escrow unit is moved to the returning position “c”. Thus, return of coins in the holding and feeding unit can be carried out immediately.

### CROSS REFERENCE TO RELATED APPLICATIONS

This is the U.S. National Phase Application under 35 U.S.C. §371 of International Patent Application No. PCT/JP2008/055358 filed Mar. 24, 2008, which claims the benefit of Japanese Patent Application No. 2007-080556 filed Mar. 27, 2007, both of which are incorporated by reference herein. The International Application was published in Japanese on Oct. 16, 2008 as WO2008/123168 A1 under PCT Article 21(2).

### TECHNICAL FIELD

The present invention relates to a coin processing method and a coin processing unit which can deposit and return an input coin.

### BACKGROUND OF THE INVENTION

As a coin processing unit, for example, there is conventionally known a proceeds depositing machine for a store which is installed in a store so that proceeds from sales unnecessary for store management can be deposited and kept.

In such a coin processing unit, a coin input into a coin inlet is received in a holding and feeding unit. The coins are fed from the holding and feeding unit to a transport path one by one to be recognized in the transport path and appropriate coins are escrowed in an escrow unit collectively. The escrow unit enables the coins to be moved between an escrow position where the coins are received from the transport path, a storing position where the escrowed coins are dropped to a coin storing unit positioned below, and a returning position where the coins escrowed in the escrow unit are dropped to a coin returning unit positioned below. Therefore, the coins escrowed in the escrow unit can be stored or returned collectively (for example, see Japanese Laid-Open Patent Publication No. 2001-67526 (p. 3, FIG. 2) (“JP '526”)).

Moreover, there is known a structure by which a foreign object or a deformed coin which cannot be fed from the holding and feeding unit is dropped from a lower part of the holding and feeding unit so that the foreign object or a deformed coin thus dropped is transferred above by a bucket of a bucket device and is returned to the coin inlet side (for example, see Japanese Laid-Open Patent Publication No. 08-212412 (p. 6, FIG. 1) (“JP '412”)).

Further, there is known a structure by which in a case where coins are returned after the coins are escrowed in the escrow unit, the escrowed coins in the escrow unit are sent to the holding and feeding unit collectively and the coins are collectively dropped from the lower part of the holding and feeding unit to be returned (for example, see Japanese Laid-Open Patent Publication No. 2006-185237 (p. 21, FIG. 18) (“JP '237”)).

However, according to the coin processing unit of JP '526, to return coins from the holding and feeding unit in a case where the coins in a coin feeding unit are returned due to cancellation of processing amid input processing, where coins in the coin feeding unit are returned because of generation of a coin unsuccessful feed caused by a large amount of deposited coins, or where a foreign object input in the coin feeding unit is returned, it was required to feed coins in the holding and feeding unit one by one to return the coins, or to open the machine body to collect the coins or a foreign object in the coin feeding unit. Therefore, it took time to return the coins or a person who is authorized had to carry out a recovery operation and this led to lowered operation efficiency.

Moreover, in the coin processing unit disclosed in JP '412, a foreign object or a deformed coin which cannot be fed from the holding and feeding unit is dropped from a lower part of the holding and feeding unit so that the foreign object or the deformed coin thus dropped is transferred above by the bucket of the bucket device to be returned to the coin inlet side. However, depending on the capacity of the bucket, the amount to be transferred at one time is limited to a small amount and therefore returning operation can be carried out little by little. In this case, it also takes time to return and leads to lowered operation efficiency.

Further, if coins in the holding and feeding unit are automatically returned collectively, it becomes possible to prevent the above-mentioned decrease in operation efficiency. However, for this purpose, it is required for the unit to have a collective returning function from the holding and feeding unit to the coin returning unit, as well as that from the escrow unit to the coin returning unit.

In the case of a coin processing unit to which a large amount of coins are deposited at one time, the unit includes an escrow unit where a large amount of coins that exceeds capacity of the holding and feeding unit are stored so that coins to be deposited are input several times. In the coin processing unit disclosed in JP '237, collective returning of coins in the escrow unit and the holding and feeding unit is realized. However, the amount of coins to be returned is limited by the capacity of the holding and feeding unit and therefore this cannot be applied to a coin processing unit in which a large amount of coins which exceeds the capacity of the holding and feeding unit is escrowed.

Further, in the coin processing unit disclosed in JP '526, to realize collective returning of coins in the holding and feeding unit, it is required that collective dispensing from the holding and feeding unit is enabled, and at the same time, a returning unit for returning a coin from the holding and feeding unit to the coin returning unit is provided in a position that does not prevent the escrow unit that is moved.

At this time, it is conceivable that the returning unit is provided in the width direction of the machine body in a case where the escrow unit is moved above the coin returning unit. However, because a cross-section of a path of the returning unit for collectively returning loose coins where the coins pass must be large to prevent the coins from jamming, width of the coin processing unit must be large. As a result of that, size of the coin processing unit becomes large.

The present invention is aimed at providing a coin processing method and a coin processing unit which can carry out collective returning of coins in the escrow unit and the holding and feeding unit in the coin processing unit to which a large amount of coins can be deposited at one time without increasing the size of the unit.

### SUMMARY OF THE INVENTION

A coin processing method according to the present invention is a coin processing method for processing coins which includes a holding and feeding step for receiving and holding coins input from a coin inlet into a holding and feeding unit and for feeding the coins thus held by the holding and feeding unit to a transport path one by one, a recognition and diversion step for transporting and recognizing coins which are fed from the holding and feeding unit to the transport path one by one and for diverting the coins on the basis of the recognition result to respective transportation destinations, an escrow step for escrowing the coins diverted from the transport path in an escrow unit, a storage step for storing the coins in the escrow unit in a coin storing unit when the input coins are stored after the temporary retention, a held coin receiving step for causing a lower part of the holding and feeding unit to be opened so that the coins in the holding and feeding unit are dropped and released and for receiving the coins thus dropped and released from the holding and feeding unit in the escrow unit when coins in the holding and feeding unit are returned, and a returning step for collectively returning the coins thus received in the escrow unit to a coin returning unit.

A coin processing method according to the present invention is the coin processing method according to the above, wherein in the escrow step, the escrow unit is moved to an escrow position where coins diverted from the transport path are received, in the storage step, the escrow unit is moved to a storing position where the escrowed coins are dropped into the coin storing unit, in the held coin receiving step, the escrow unit is moved to an ejection position where the coins dropped and released from the holding and feeding unit are received, and in the returning step, the escrow unit is moved to a returning position where the escrowed coins are dropped to the coin returning unit.

A coin processing method according to the present invention is the coin processing method according to the above, wherein any of two positions among the escrow position where the escrow unit receives the coins diverted from the transport path, the ejection position where the coins dropped and released from the holding and feeding unit are received by the escrow unit, the returning position where the coins escrowed in the escrow unit are dropped to the coin returning unit, and the storing position where the coins escrowed in the escrow unit are dropped to the coin storing unit, are in the same position and in each of the escrow step, storage step, held coin receiving step, and returning step, the escrow unit is moved to the positions corresponding to each of the steps.

A coin processing method according to the present invention is the coin processing method according to the above, wherein any of three positions among the escrow position where the escrow unit receives the coins diverted from the transport path, the ejection position where the coins dropped and released from the holding and feeding unit are received by the escrow unit, the returning position where the coins escrowed in the escrow unit are dropped to the coin returning unit, and the storing position where the coins escrowed in the escrow unit are dropped to the coin storing unit, are in the same position and in each of the escrow step, storage step, held coin receiving step, and returning step, the escrow unit is moved to the positions corresponding to each of the steps.

A coin processing method according to the present invention is the coin processing method according to the above, wherein any of two positions and remaining two positions among the escrow position where the escrow unit receives the coins diverted from the transport path, the ejection position where the coins dropped and released from the holding and feeding unit are received by the escrow unit, the returning position where the coins escrowed in the escrow unit are dropped to the coin returning unit, and the storing position where the coins escrowed in the escrow unit are dropped to the coin storing unit, are respectively in the same positions and in each of the escrow step, storage step, held coin receiving step, and returning step, the escrow unit is moved to the positions corresponding to each of the steps.

A coin processing unit according to the present invention is a coin processing unit for processing coins including a holding and feeding unit for receiving and holding coins input from a coin inlet, feeding the coins one by one, and opening a lower part of the unit so that the coins can be dropped and released, a transport path for transporting the coins fed from the holding and feeding unit one by one, recognizing the coins under transportation by way of a recognition unit provided in the middle of a transport passage of the coins, and diverting the coins by destinations on the basis of the recognition result, an escrow unit for escrowing the coins diverted from the transport path, a coin storing unit for storing the coins which are escrowed in the escrow unit, a coin returning unit for returning the coins escrowed in the escrow unit and coins held in the holding and feeding unit, a driving unit for moving the escrow unit to an escrow position where the coins diverted from the transport path to be escrowed are received, an ejection position where the coins dropped and released from the holding and feeding unit are received, a returning position where the escrowed coins are dropped to the coin returning unit, and a storing position where the escrowed coins are dropped to the coin storing unit, and a control unit which moves the escrow unit to the ejection position so that the coins can be dropped and released from the holding and feeding unit and subsequently moves the escrow unit to the returning position so that the coins can be dropped to the coin returning unit.

A coin processing unit according to the present invention is a coin processing unit for processing coins including a holding and feeding unit for receiving and holding coins input from a coin inlet, feeding the coins one by one, and opening a lower part of the unit so that the coins can be dropped and released, a transport path for transporting the coins fed from the holding and feeding unit one by one, recognizing the coins under transportation by way of a recognition unit provided in the middle of a transport passage of the coins, and diverting the coins by destinations on the basis of the recognition result, an escrow unit for escrowing the coins diverted from the transport path, a coin storing unit for storing the coins which are escrowed in the escrow unit, a coin returning unit for returning the coins escrowed in the escrow unit and coins held in the holding and feeding unit, a driving unit for moving the escrow unit to the following positions; an escrow position where the coins diverted from the transport path to be escrowed are received by the escrow unit, an ejection position where the coins dropped and released from the holding and feeding unit are received by the escrow unit, a returning position where the coins escrowed in the escrow unit are dropped to the coin returning unit, and a storing position where the coins escrowed in the escrow unit are dropped to the coin storing unit; wherein any two of the positions are in one same position, and a control unit for dropping and dispensing the coins in the holding and feeding unit to the escrow unit and for dropping the coins from the escrow unit to the coin returning unit.

A coin processing unit according to the present invention is a coin processing unit for processing coins including a holding and feeding unit for receiving and holding coins input from a coin inlet, feeding the coins one by one, and opening a lower part of the unit so that the coins can be dropped and released, a transport path for transporting the coins fed from the holding and feeding unit one by one, recognizing the coins under transportation by way of a recognition unit provided in the middle of the transport passage of the coins, and diverting the coins by destinations on the basis of the recognition result, an escrow unit for escrowing the coins diverted from the transport path to be escrowed, a coin storing unit for storing the coins which are escrowed in the escrow unit, a coin returning unit for returning the coins escrowed in the escrow unit and coins held in the holding and feeding unit, a driving unit for moving the escrow unit to the following positions; an escrow position where the coins diverted from the transport path to be escrowed are received by the escrow unit, an ejection position where the coins dropped and released from the holding and feeding unit are received by the escrow unit, a returning position where the coins escrowed in the escrow unit are dropped to the coin returning unit, and a storing position where the coins escrowed in the escrow unit are dropped to the coin storing unit; wherein any three of the positions are in one same position, and a control unit for dropping and dispensing the coins in the holding and feeding unit to the escrow unit and for dropping the coins from the escrow unit to the coin returning unit.

A coin processing unit according to the present invention is a coin processing unit for processing coins including a holding and feeding unit for receiving and holding coins input from a coin inlet, feeding the coins one by one, and opening a lower part of the unit so that the coins can be dropped and released, a transport path for transporting the coins fed from the holding and feeding unit one by one, recognizing the coins under transportation by way of a recognition unit provided in the middle of a transport passage of the coins, and diverting the coins by destinations on the basis of the recognition result, an escrow unit for escrowing the coins diverted from the transport path, a coin storing unit for storing the coins which are escrowed in the escrow unit, a coin returning unit for returning the coins escrowed in the escrow unit and coins held in the holding and feeding unit, a driving unit for moving the escrow unit to the following positions; an escrow position where the coins diverted from the transport path to be escrowed are received by the escrow unit, an ejection position where the coins dropped and released from the holding and feeding unit are received by the escrow unit, a returning position where the coins escrowed in the escrow unit are dropped to the coin returning unit, and a storing position where the coins escrowed in the escrow unit are dropped to the coin storing unit; wherein any two of the positions are in one same position while remaining two positions are also in one same position, and a control unit for dropping and dispensing the coins in the holding and feeding unit to the escrow unit and for dropping the coins from the escrow unit to the coin returning unit.

A coin processing unit according to the present invention is the coin processing unit according to any one of the above, wherein a movable bottom plate, which can open and close the bottom surface of the escrow unit, is provided movably along the moving direction of the escrow unit.

A coin processing unit according to the present invention is the coin processing unit according to any one of the above, wherein a bottom surface shutter for opening and closing a bottom surface of the escrow unit is provided to the escrow unit.

With the coin processing method according to the present invention, when coins in the holding and feeding unit are returned, the lower part of the holding and feeding unit is caused to be opened so that the coins in the holding and feeding unit are dropped and released, the coins thus dropped and released from the holding and feeding unit are received in the escrow unit, and the coins thus received in the escrow unit can be returned to the coin returning unit collectively. Therefore, it becomes possible to quickly respond to returning of coins in the holding and feeding unit when an unsuccessful feed from the holding and feeding unit due to cancellation of depositing process or input of a large amount of coins occurs and to returning of a foreign object that remains in the holding and feeding unit without increasing the size of a unit even if the unit can deposit a large amount of coins at one time. Therefore, operation efficiency can be improved.

With the coin processing method according to the present invention, the stopping positions of the escrow unit include the escrow position where coins diverted from the transport path are received, the storing position where the escrowed coins are dropped into the coin storing unit, the ejection position where the coins dropped and released from the holding and feeding unit are received, and the returning position where the escrowed coins are dropped to the coin returning unit. Therefore, operation in each of the steps can be reliably carried out.

With the coin processing method according to the present invention, any two of the positions of the escrow position where coins diverted from the transport path are received by the escrow unit, the ejection position where the coins dropped and released from the holding and feeding unit are received by the escrow unit, the returning position where the coins escrowed in the escrow unit are dropped to the coin returning unit, and the storing position where the coins escrowed in the escrow unit are dropped into the coin storing unit are in one same position. That is, the number of stopping positions of the escrow unit is set to be three and the escrow unit is moved to each of the positions which corresponds to each of the escrow step, the storage step, the held coin receiving step, and the returning step, so that a smaller unit can be realized.

With the coin processing method according to the present invention, any three of the positions of the escrow position where coins diverted from the transport path are received by the escrow unit, the ejection position where the coins dropped and released from the holding and feeding unit are received by the escrow unit, the returning position where the coins escrowed in the escrow unit are dropped to the coin returning unit, and the storing position where the coins escrowed in the escrow unit are dropped into the coin storing unit are in one same position. That is, the number of stopping positions of the escrow unit is set to be two and the escrow unit is moved to each of the positions which corresponds to each of the escrow step, the storage step, the held coin receiving step, and the returning step, so that a smaller unit can be realized.

With the coin processing method according to the present invention, any two of the positions of the escrow position where coins diverted from the transport path are received by the escrow unit, the ejection position where the coins dropped and released from the holding and feeding unit are received by the escrow unit, the returning position where the coins escrowed in the escrow unit are dropped to the coin returning unit, and the storing position where the coins escrowed in the escrow unit are dropped into the coin storing unit are in one same position while the remaining two positions are also in one same position. That is, the number of stopping positions of the escrow unit is set to be two and the escrow unit is moved to each of the positions which corresponds to each of the escrow step, the storage step, the held coin receiving step, and the returning step, so that a smaller unit can be realized.

With the coin processing unit according to the present invention, the stopping positions of the escrow unit include an escrow position where the coins diverted from the transport path to be escrowed are received by the escrow unit, an ejection position where the coins dropped and released from the holding and feeding unit are received by the escrow unit, a returning position where the coins escrowed in the escrow unit are dropped to the coin returning unit, and a storing position where the coins escrowed in the escrow unit are dropped to the coin storing unit. Therefore, it becomes possible to move the escrow unit to the ejection position and to drop and release the coins from the holding and feeding unit and subsequently to move the escrow unit to the returning position so that the coins are dropped to the coin returning unit to be collectively returned. Therefore, it becomes possible to quickly respond to returning of coins in the holding and feeding unit when an unsuccessful feed from the holding and feeding unit due to cancellation of depositing process or input of a large amount of coins occurs and to returning of a foreign object that remains in the holding and feeding unit without increasing the size of a unit even in a case where the unit can deposit a large amount of coins at one time. At the same time, operation efficiency can be improved.

With the coin processing unit according to the present invention, any two of the positions of the escrow position where coins diverted from the transport path to be escrowed are received by the escrow unit, the ejection position where the coins dropped and released from the holding and feeding unit are received by the escrow unit, the returning position where the coins escrowed in the escrow unit are dropped to the coin returning unit, and the storing position where the coins escrowed in the escrow unit are dropped into the coin storing unit are in one same position. That is, the number of stopping positions of the escrow unit is set to be three and the escrow unit is moved to each of these positions to allow the coins in the holding and feeding unit to be dropped and released to the escrow unit, so that the coins can be dropped to the coin returning unit from the escrow unit to be collectively returned. Therefore, it becomes possible to quickly respond to returning of coins in the holding and feeding unit when an unsuccessful feed from the holding and feeding unit due to cancellation of depositing processor input of a large amount of coins occurs and to returning of a foreign object that remains in the holding and feeding unit without increasing the size of a unit even in a case where the unit can deposit a large amount of coins at one time. At the same time, operation efficiency can be improved.

With the coin processing unit according to the present invention, any three of the positions of the escrow position where coins diverted from the transport path to be escrowed are received by the escrow unit, the ejection position where the coins dropped and released from the holding and feeding unit are received by the escrow unit, the returning position where the coins escrowed in the escrow unit are dropped to the coin returning unit, and the storing position where the coins escrowed in the escrow unit are dropped into the coin storing unit are in one same position. That is, the number of stopping positions of the escrow unit is set to be two and the escrow unit is moved to each of the positions to allow the coins in the holding and feeding unit to be dropped and released to the escrow unit, so that the coins can be dropped to the coin returning unit from the escrow unit to be collectively returned. Therefore, it becomes possible to quickly respond to returning of coins in the holding and feeding unit when an unsuccessful feed from the holding and feeding unit due to cancellation of depositing process or input of a large amount of coins occurs and to returning of a foreign object that remains in the holding and feeding unit without increasing the size of a unit even in a case where the unit can deposit a large amount of coins. At the same time, operation efficiency can be improved.

With the coin processing unit according to the present invention, any two of the positions of the escrow position where coins diverted from the transport path are received by the escrow unit, the ejection position where the coins dropped and released from the holding and feeding unit are received by the escrow unit, the returning position where the coins escrowed in the escrow unit are dropped to the coin returning unit, and the storing position where the coins escrowed in the escrow unit are dropped into the coin storing unit are in one same position while the remaining two positions are also in one same position. That is, the number of stopping positions of the escrow unit is set to be two and the escrow unit is moved to each of the positions to allow the coins in the holding and feeding unit to be dropped and released to the escrow unit so that the coins can be dropped to the coin returning unit from the escrow unit to be collectively returned. Therefore, it becomes possible to quickly respond to returning of coins in the holding and feeding unit when an unsuccessful feed from the holding and feeding unit due to cancellation of depositing process or input of a large amount of coins occurs and to returning of a foreign object that remains in the holding and feeding unit without increasing the size of a unit even in a case where the unit can deposit a large amount of coins. At the same time, operation efficiency can be improved.

With the coin processing unit according to the present invention, the movable bottom plate which can open and close the bottom surface of the escrow unit is provided along the moving direction of the escrow unit. Therefore, it becomes possible for the escrow unit positioned in the escrow position to carry out temporary retention and dropping and dispensing of the coins.

With the coin processing unit according to the present invention, the bottom surface shutter for opening and closing the bottom surface of the escrow unit is provided to the escrow unit. Therefore, it becomes possible for the escrow unit positioned in the escrow position to carry out temporary retention and dropping and dispensing of the coins.

### BRIEF DESCRIPTION OF THE DRAWINGS

FIG. 1 is a side view showing an inner structure of a proceeds depositing machine for a store using a coin processing unit which shows an embodiment of the present invention.

FIG. 2 is a perspective view of the proceeds depositing machine for a store.

FIG. 3 shows the inner structure of the proceeds depositing machine for a store. FIG. 3 (a) is a side view of the coin processing unit, and FIG. 3 (b) is a side view of a banknote processing unit.

FIG. 4 shows a structure of an inlet and periphery thereof of the banknote processing unit. FIG. 4(a) is a side view showing a condition where a cover is opened, and FIG. 4(b) is a side view showing a condition where a cover is closed.

FIG. 5 is a block diagram of the proceeds depositing machine for a store.

FIG. 6 is an explanatory view for explanation of operation of the coin processing unit in (a) to (d).

FIG. 7 is a side view showing an inner structure of a coin processing unit which shows another embodiment of the present invention.

FIG. 8 is a side view showing an inner structure of a coin processing unit which shows a further embodiment of the present invention.

FIG. 9 is a side view showing an inner structure of a coin processing unit which shows an embodiment of the present invention.

FIG. 10 is a side view showing an inner structure of a coin processing unit which shows another embodiment of the present invention.

FIG. 11 is a side view showing an inner structure of a coin processing unit which shows a further embodiment of the present invention.

FIG. 12 is a side view showing an inner structure of a coin processing unit which shows an embodiment of the present invention.

FIG. 13 is a side view showing an inner structure of a coin processing unit which shows another embodiment of the present invention.

### DETAILED DESCRIPTION OF THE INVENTION

Hereinafter, an embodiment of the present invention will be described with reference to the drawings.

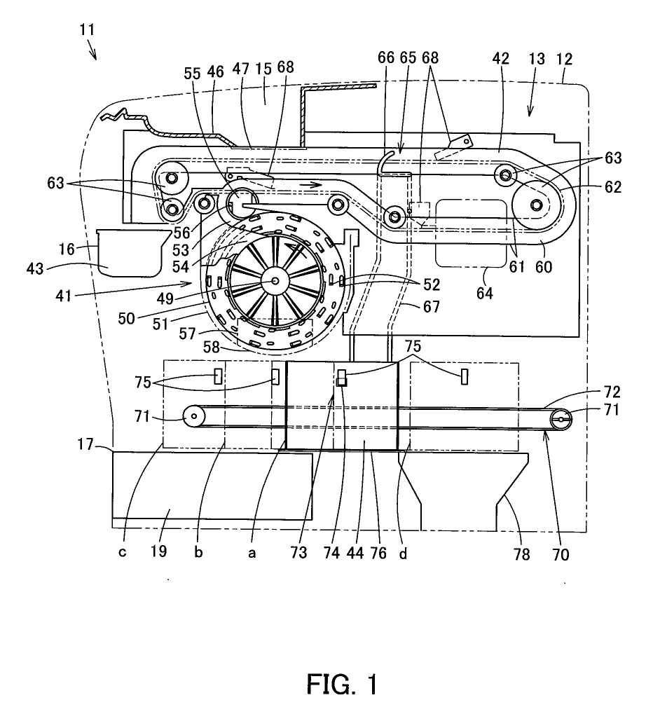

An embodiment is shown in FIG. 1 to FIG. 6 which is an example in which four positions are provided as stopping positions for an escrow unit.

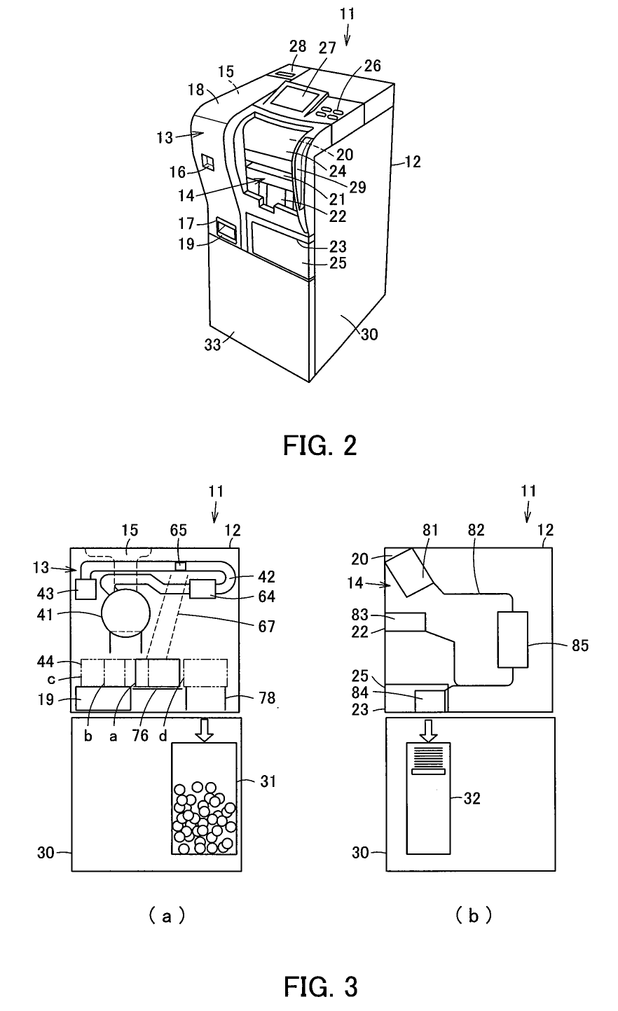

In FIG. 2, 11 is a proceeds depositing machine for a store. This proceeds depositing machine for a store 11 is installed in a store for depositing and keeping proceeds from sales unnecessary for store management and has a machine body 12. On the left side of the machine body 12, a coin processing unit 13 for processing coins is provided and on the right side of the machine body 12, a banknote processing unit 14 for processing banknotes is provided.

The coin processing unit 13 includes a coin inlet 15 for receiving a coin to be deposited, a coin reject port 16 for returning a rejected coin among coins to be deposited, and a coin return port 17 for returning a coin to be deposited in a case where the deposit of money is cancelled before the coin to be deposited is stored. A coin inlet cover 18 which can be opened and closed is provided to the coin inlet 15 and a returning box 19 as a coin returning unit is provided drawable to the coin return port 17.

The banknote processing unit 14 includes a banknote inlet 20 for putting in a plurality of banknotes from a short edge direction, a foreign object removing port 21 to which a foreign object put in the banknote inlet 20 is ejected to be removed, a banknote reject port 22 for returning a rejected banknote among banknotes to be deposited, and a banknote return port 23 for returning a banknote to be deposited in a case where the deposit of money is cancelled before the banknote to be deposited is stored. A banknote inlet cover 24 which can be opened and closed is provided to the banknote inlet 20 and a door 25 which is opened when a returned banknote is removed is provided to the banknote return port 23.

On an upper surface of the machine body 12, an operation unit 26 for operating deposit, a display unit 27 for displaying a display related to operation of deposit or the like, and a printer 28 for carrying out printing related to operation of deposit are provided. On a front surface of the machine body 12, a card reader 29 for checking authority for operation of an operator is provided.

A lower part of the machine body 12 is a storing unit 30 which stores a coin cassette 31 as a coin storing unit or a banknote cassette 32 detachably (refer to FIG. 3). To the storing unit 30, a cabinet 33 which can be pulled to the front surface side of the machine body 12 by a specified person for collection such as a security agent of a security company to whom collection of proceeds from sales is delegated is provided.

Next, as shown in FIG. 1 and FIG. 3(a), the coin processing unit 13 includes the coin inlet 15, a holding and feeding unit 41 which receives coins input from the coin inlet 15 to hold them, feeds the coins one by one, and opens a lower part of the unit so that the coins can be dropped and released, a transport path 42 for transporting the coins fed from the holding and feeding unit 41 one by one, recognizing authenticity and denomination of coins by way of a recognition unit 64 in the middle of the transportation of the coins, and diverting the coins by destinations on the basis of the recognition result, a coin reject unit 43 which returns a coin rejected from the transport path 42, an escrow unit 44 for escrowing the coins sent from the transport path 42, the coin cassette 31 for storing the coins escrowed in the escrow unit 44 according to a storage instruction, and a returning box 19 for returning the coins escrowed in the escrow unit 44 and coins held in the holding and feeding unit according to a return instruction.

Coin storage capacity of the holding and feeding unit 41 is approximately 200 pieces and coin storage capacity of the escrow unit 44 is approximately 400 pieces. Therefore, coins which exceed the coin storage capacity of the holding and feeding unit 41 can be stored in the escrow unit 44.

Then, the coin inlet 15 is opened to be formed in a deeper position of a bottom surface which is shaped to have a recessed shape at a coin receiving unit 46 provided on the upper surface of the machine body 12. On a lower surface of the coin inlet 15, a coin inlet shutter 47 which can be opened and closed is provided.

Moreover, the holding and feeding unit 41 includes a rotary disc 50 rotatable around a rotary axis 49 at a position tilted at a predetermined angle in relation to a horizontal direction; and a hopper 51 for accepting and holding coins between the hopper and a surface side of the rotary disc 50.

The rotary disc 50 is tilted rightward in relation to the horizontal direction when seen from the front surface of the machine body 12 (when seen from left side of FIG. 1) and is provided obliquely so that left upper side of the rotary disc 50 is higher while the right lower side of the disc is lower and the surface of the rotary disc 50 is caused to face obliquely upward to the right. The disk is rotated by a driving force of a motor (not shown). On the surface of the rotary disc 50, a plurality of picking-up members 52 for picking up coins in the hopper 51 one by one by the rotation of the rotary disc 50 are provided in the vicinity of the periphery of the rotary disc 50 at a predetermined pitch.

In an upper area of the rotary disc 50, a feeding path unit 53 for feeding coins, which were picked up one by one by the picking-up member 52 in the upper area, one by one to a front edge part which is an entrance unit of the transport path 42 is formed. In this feeding path unit 53, the coins which were picked up onto the upper area of the rotary disc 50 by the picking-up member 52 one by one are received in the feeding path unit 53 by a receiving guide 54, and at the same time, coins in the feeding path unit 53 are fed to the transport path 42 by a receiving disk 55 provided in the feeding path unit 53. The receiving disk 55 is rotated by driving force of a motor (not shown). A protrusion 56 provided in a protruding manner in a peripheral portion of the receiving disk 55 comes into contact with the peripheral portion of the coins so that the coins are fed to the transport path 42 one by one.

The hopper 51 covers the surface side of the rotary disc 50, and at the same time, has an opening on an upper surface side of the hopper so that coins input from the coin inlet 15 provided above can be received. In a lower part of the hopper 51, a dispensing port 57 is formed and an opening/closing unit 58 which is opened and closed by an opening/closing driving unit such as a solenoid or a motor is provided to the dispensing port 57. The opening/closing unit 58 is enabled to be opened and closed here.

Moreover, the transport path 42 includes a path surface 60 which transports coins fed by the holding and feeding unit 41 one by one, and guide units 61 on both sides for guiding the peripheral portion of a coin to be transported on the passage surface 60. The passage surface 60 is formed in a tilted manner similar to the surface of the rotary disc 50. The transport path 42 is stretched from the entrance unit which is connected to the feeding path unit 53 of the holding and feeding unit 41 toward the deeper side of the machine body 12, and at the same time, the transport path 42 is stretched to the front side of the machine body 12 as the transport path 42 is folded back to the upper side at the deeper side of the machine body 12, so that an end portion of the transport path 42 reaches an upper surface of the coin reject unit 43.

On the passage surface 60 of the transport path 42, an endless transporting belt 62 is provided in a tensioned manner by a plurality of pulleys 63. Pins (not shown) which come into contact with the peripheral portion of the coins to push and transport the coins in the transport path 42 are provided in the transporting belt 62 at a predetermined pitch along the longitudinal direction of the transporting belt 62. That is, coins fed one by one from the holding and feeding unit 41 by the receiving disk 55 are received between pins in the front and back of the transportation direction of the transporting belt 62 and the coins are pushed by the pins on the back side of the transportation direction so that the coins are pushed to the transportation direction and transported.

In the middle of the transport path 42, a recognition unit 64 for recognizing authenticity and denomination of coins to be transported is provided.

In the middle of the transport path 42 on a downstream side of the transportation direction from the recognition unit 64, a diversion unit 65 for diverting a coin, which is to be escrowed and is recognized as a genuine coin by the recognition unit 64, from the transport path 42 is provided. The diversion unit 65 includes a diversion member 66 and on the basis of a result of the recognition unit 64, the diversion member 66 moves front and back into the transport path 42 by a diversion driving unit such as a solenoid to divert coins to be escrowed from the transport path 42, and at the same time, allows a rejected coin to pass through. At the position of the diversion unit 65, an upper edge portion of a chute for escrow 67 for receiving the coin diverted by the diversion unit 65 and guiding the coin below is provided. A lower edge portion of the chute for escrow 67 is provided above the escrow unit 44 positioned at the escrow position.

Biasing units 68 for pushing a coin toward the guide unit 61 on the lower side to ensure recognition and diversion of a coin are provided respectively to the entrance unit of the transport path 42, an upper stream side position in the transportation direction of the recognition unit 64, and an upper stream side position of the transportation direction of the diversion unit 65 on the transport path 42.

Moreover, the coin reject unit 43 is formed inside the coin reject port 16, accepts a rejected coin which is transported to the end edge portion of the transport path 42, and enables the coin to be removed from the coin reject port 16.

Further, the escrow unit 44 is formed to have a frame shape which is opened in vertical directions, is provided in a lower side area of the holding and feeding unit 41 in the machine body 12, and is moved in the depth direction of the machine body 12 by a driving unit 70. The driving unit 70 includes a driving belt 72 provided along the depth direction of the machine body 12 by a pulley 71 and a motor for rotation driving the driving belt 72 (not shown). The escrow unit 44 is connected to a part of the driving belt 72 and along with the rotation movement of the driving belt 72, the escrow unit 44 is moved in the depth direction.

Moving position (stopping position) of the escrow unit 44 includes the following four positions: an escrow position “a” where a coin to be escrowed, which is sent from the transport path 42 via the chute for escrow 67, is received; an ejection position “b” where a coin which is dropped and released by opening of the opening/closing unit 58 of the holding and feeding unit 41 is received; a returning position “c” where the escrowed coin is dropped into the returning box 19; and a storing position “d” where the escrowed coin is dropped into the coin cassette 31. Each of the positions “a” to “d” of the escrow unit 44 is detected by a position detection unit 73. The position detection unit 73 includes a detection chip 74 attached to the escrow unit and a sensor unit 75 for detecting the detection chip 74 when the escrow unit 44 is moved to each of the positions “a” to “d.” The escrow unit 44 sets the escrow position “a” as its regular position.

On a lower side of the escrow unit 44 positioned at the escrow position “a,” a bottom plate 76 for closing a lower surface of the escrow unit 44 is provided to the machine body 12 side. Therefore, when the escrow unit 44 is moved to the ejection position “b” and to the returning position “c” which are on the front side of the machine body 12 and when the escrow unit 44 is moved to the storing position “d” which is on a deeper side of the machine body 12, the escrow unit 44 leaves the bottom plate 76 and the bottom surface of the escrow unit 44 is opened.

Moreover, because the coin cassette 31 is provided on a deeper side of the storing unit 30 of the machine body 12, the coin cassette 31 receives and stores the escrowed coins from the escrow unit 44, which moves to the storing position “d” which is on the deeper side of the machine body 12, via a chute for storage 78.

Further, because the returning box 19 is provided on a front side of the machine body 12, the returning box 19 receives and stores escrowed coins from the escrow unit 44 which moves to the ejection position “b” and returning position “c” which are on the front side of the machine body 12 and coins held in the holding and feeding unit 41.

Next, as shown in FIG. 3(b), the banknote processing unit 14 includes a banknote inlet 20, a holding and feeding unit 81 for receiving and holding the banknote input from the banknote inlet 20 and for feeding the banknotes one by one, a transport path 82 for transporting the banknotes fed from the holding and feeding unit 81 one by one, recognizing the authenticity and denomination of the banknotes, counting the banknotes to be escrowed on the basis of the recognition result, and at the same time, for diverting the banknotes by destination, a banknote reject unit 83 for returning a banknote rejected by the transport path 82, an escrow unit 84 for escrowing a banknote to be escrowed which is fed from the transport path 82, the banknote cassette 32 for storing the banknotes which are escrowed in the escrow unit 84 according to a storage instruction, and a door 25 which is enabled to be opened to return the banknote which is escrowed in the escrow unit 84 according to a return instruction.

A recognition unit 85 for recognizing authenticity and denomination of a banknote to be transported is provided to the transport path 82.

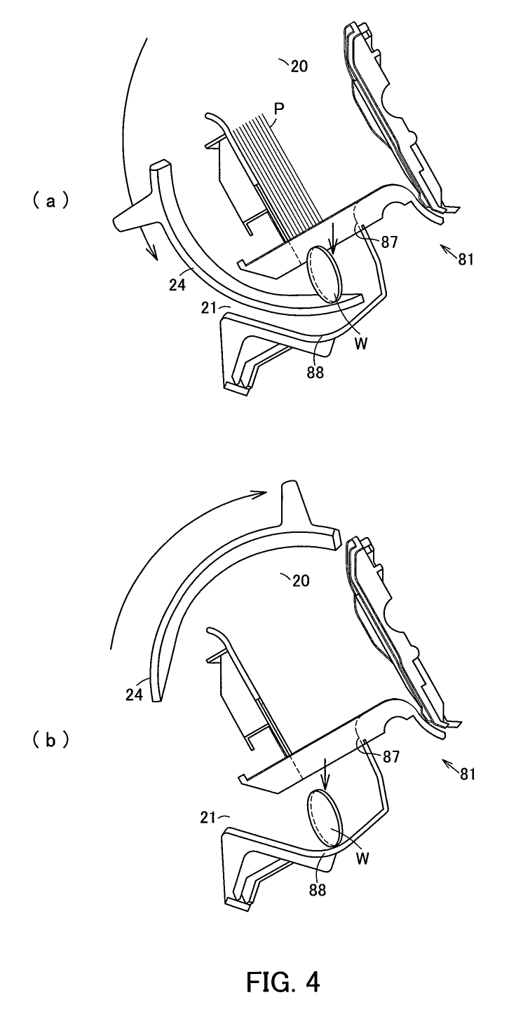

Moreover, as shown in FIGS. 4(a) and (b), the holding and feeding unit 81 is provided inside the banknote inlet 20 and at the bottom portion of the holding and feeding unit 81, a foreign object dropping port 87 for dropping, for example, a foreign object such as a coin (indicated by W in the drawing) which is mixed in the banknotes (indicated by P in the drawing) and input is formed. A foreign object receiving unit 88 for receiving the foreign object that is dropped from the foreign object dropping port 87 is formed below the foreign object dropping port 87 and in front of the foreign object receiving unit 88, a foreign object removing port 21 is formed.

A banknote inlet cover 24 for opening and closing the banknote inlet 20 is formed to have a circular cross-section and is moved vertically to open and close the banknote inlet 20. When the cover is opened, a lower edge side of the banknote inlet cover 24 slips in between the foreign object dropping port 87 and the foreign object receiving unit 88 from the foreign object removing port 21.

In a condition where the banknote inlet cover 24 is closed, water, oil, or other foreign objects are prevented from entering into the banknote inlet 20.

When banknotes are put in, if the banknote inlet cover 24 is opened and a foreign object which is input with the banknotes from the banknote inlet 20 is dropped from the foreign object dropping port 87 in a condition where the lower edge side of the banknote inlet cover 24 is put in a lower side of the foreign object dropping port 87, the foreign object is received by the banknote inlet cover 24. Thus, it becomes possible to prevent the foreign object from jumping out of the machine body 12 from the foreign object removing port 21. If the banknote inlet cover 24 is closed after the banknotes are fed from the holding and feeding unit 81, a foreign object on the banknote inlet cover 24 is dropped on the foreign object receiving unit 88 and it becomes possible to remove the foreign object via the foreign object removing port 21.

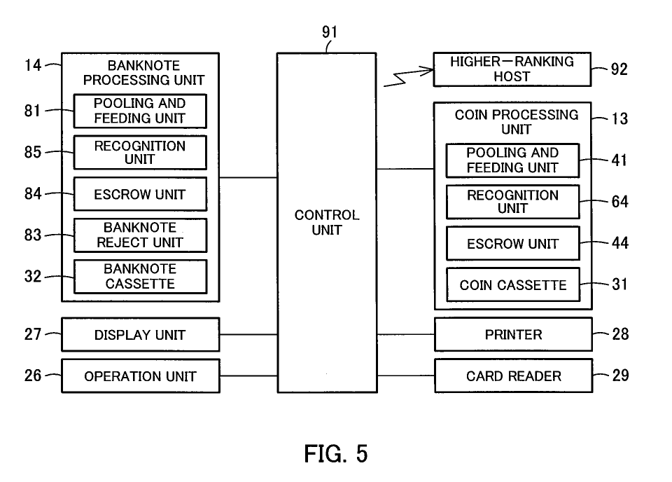

Next, as shown in FIG. 5, the coin processing unit 13, the banknote processing unit 14, the operation unit 26, the display unit 27, the printer 28, the card reader 29, and the like are connected to the control unit 91 for controlling the proceeds depositing machine for a store 11. Moreover, the control unit 91 is enabled to communicate with a higher-ranking host 92 such as a security company to whom collection of proceeds from sales is delegated.

Then, the control unit 91 has a function to move the escrow unit 44 to the ejection position “b” to drop and release coins from the holding and feeding unit 41 and subsequently to move the escrow unit 44 to the returning position “c” so that coins are collectively returned to the returning box 19.

Next, effect of the present embodiment will be described.

Operation of the coin processing unit 13 will be described.

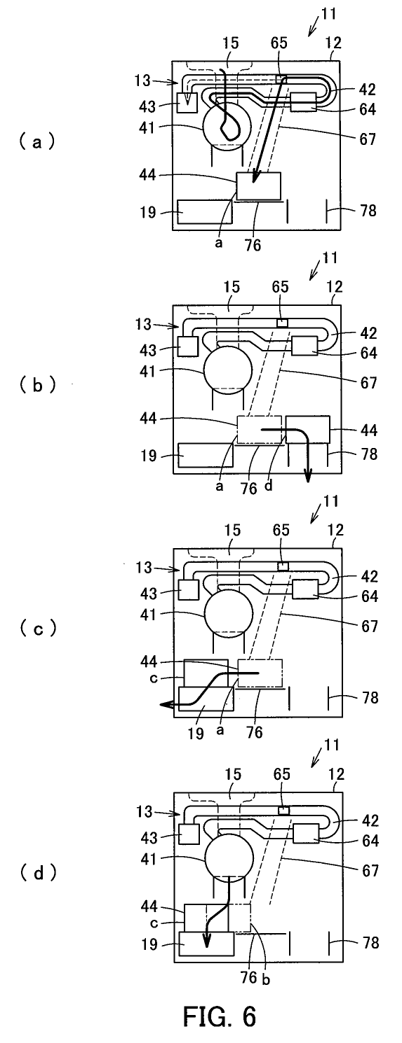

First, depositing operation is shown in FIG. 6(a).

An operator operates a delivery key (a key for allowing deposit of coins into the coin cassette 31 managed by a security company to which collection operation of proceeds from sales was delegated by the store side), causes the card reader 29 to read an ID card, sets coins in the coin receiving unit 46, and operates a start key of the operation unit 26. Here, the start key is common to both the coin processing unit 13 and the banknote processing unit 14 and depositing operation of banknotes is started simultaneously with start of the depositing operation of coins by the operation of the start key.

If deposit is instructed by the operation of the start key in the operation unit 26, it is checked whether or not the escrow unit 44 is positioned in the escrow position “a” which is the regular position. If the escrow unit 44 is positioned in the escrow position “a,” the coin inlet shutter 47 is automatically opened.

When the coin inlet shutter 47 is opened, coins in the coin receiving unit 46 are dropped from the coin inlet 15 and are received by the holding and feeding unit 41 to be held. Here, a full-state detection sensor for detecting that the coin storage capacity reached its limit is provided to the holding and feeding unit 41, and in a case where it is detected that the capacity has reached its limit, the coin inlet shutter 47 is automatically closed temporarily and is opened automatically after the amount of coins in the holding and feeding unit 41 is reduced by feeding coins by the holding and feeding unit 41. Thus, the amount of coins in the holding and feeding unit 41 is controlled. Moreover, coins remaining on the bottom surface of the coin receiving unit 46 are manually input into the coin inlet 15 by the operator.

By the feeding operation of the holding and feeding unit 41, coins in the holding and feeding unit 41 are fed to the transport path 42 one by one (holding and feeding step).

The coins fed to the transport path 42 are transported and recognized by the recognition unit 64, so that genuine coins are counted. The coins which are recognized as genuine coins by the recognition unit 64 are diverted from the transport path 42 by the diversion unit 65 (recognition and diversion step).

The coins diverted by the diversion unit 65 are sent to the escrow unit 44 positioned in the escrow position “a” through the chute for escrow 67. The bottom surface of the escrow unit 44 positioned in the escrow position “a” is closed by the bottom plate 76, and coins sent by the chute for escrow 67 are received to be escrowed (escrow step).

A coin recognized as a rejected coin by the recognition unit 64 is transported to an edge of the transport path 42 and is returned to the coin reject unit 43.

Moreover, for example, if abnormality in transportation of a coin on the transport path 42 occurs due to the jumping of the coin over one of a plurality of coin detection sensors provided along the transport path 42 or the like, the diversion unit 65 is immediately switched to the rejection side, feeding of coins from the holding and feeding unit 41 is immediately stopped, all the undetermined coins on the transport path 42 are transported to the end of the transport path 42 to be returned to the coin reject unit 43, and transportation by the transport path 42 is stopped. After the coins returned to the coin reject unit 43 are removed, depositing operation of coins in the holding and feeding unit 41 is restarted. Thus, it is prevented that an undetermined coin by a diversion error or the like on the transport path 42 is mixed into determined coins.

If it is checked by a sensor provided to the holding and feeding unit 41 that a coin does not remain in the unit for more than a predetermined period of time, feeding operation of the holding and feeding unit 41 and transportation operation of the transport path 42 are stopped.

Here, assume a case where an additional banknote is deposited in a condition where counting by depositing operation of coins and banknotes is over and coins exist in the escrow unit 44. If a banknote is input into the banknote inlet 20, a sensor provided to the banknote inlet 20 detects the banknote and depositing operation of banknotes is automatically restarted. Moreover, in a case where coins are additionally deposited, coin depositing operation is restarted when the coins to be additionally input are input from the coin inlet 15 and start key of the operation unit 26 is operated.

Subsequently, storage operation after temporary retention (storage step) is shown in FIG. 6(b).

When the operator, who checked the result of counting which is displayed on the display unit 27, instructs storage through the operation unit 26, the escrow unit 44 is moved from the escrow position “a” to the storing position “d” on the deeper side of the machine body 12. By this movement of the escrow unit 44, the escrow unit 44 is released from the bottom plate 76 and the bottom surface thereof is opened. The bottom surface of the escrow unit 44 is completely opened above the chute for storage 78 and coins escrowed in the escrow unit 44 are dropped into the chute for storage 78 and stored in the coin cassette 31 in the storing unit 30.

Subsequently, the escrow unit 44 is returned to the escrow position “a” which is the regular position.

Next, returning operation after temporary retention is shown in FIG. 6(c).

When the operator who checked the result of counting, which is displayed on the display unit 27, instructs returning through the operation unit 26, the escrow unit 44 is moved from the escrow position “a” to the returning position “c” on the front side of the machine body 12. By this movement of the escrow unit 44, the escrow unit 44 is released from the bottom plate 76 and the bottom surface is opened. The bottom surface of the escrow unit 44 is completely opened above the returning box 19 and coins escrowed in the escrow unit 44 are dropped into the returning box 19 to be stored.

Subsequently, the escrow unit 44 is returned to the escrow position “a” which is the regular position.

Then, the operator pulls out the returning box 19 from the machine body 12 to collect returned coins.

Moreover, if a large amount of coins is input in the coin inlet 15, there may be a case where the capacity of the escrow unit 44 where the coins are escrowed is fulfilled. The capacity of coins of the escrow unit 44 can be understood by the count of a countable number value by the recognition unit 64, and if it is detected that the escrow unit 44 is fulfilled, depositing operation is temporarily stopped and an instruction by the operator for storage or returning of the coins is waited. If storage or returning is instructed, the above-mentioned storage operation in FIG. 6(b) or returning operation of FIG. 6(c) is carried out. Then, in a case where the storage operation is instructed, depositing operation is automatically restarted after the completion of the storage operation, and in a case where the returning operation is instructed, depositing operation is automatically restarted after pulling out and resetting of the returning box 19 are carried out.

Subsequently, ejection and returning operation including ejection of a coin in the holding and feeding unit 41 is shown in FIG. 6(d).

As an example of carrying out the ejection and returning operation, there is a case where the operator instructs return of a coin through the operation unit 26 during escrow operation of feeding coins to be deposited which were received in the holding and feeding unit 41.

In this case, feeding operation from the holding and feeding unit 41 is stopped and processing of coins being transported on the transport path 42 is completed. Then, the escrow unit 44 is moved to the ejection position “b” on the front side of the machine body 12. By this movement of the escrow unit 44, part of the bottom surface of the escrow unit 44 is released from the bottom plate 76 and is opened. Therefore, a part of the escrowed coins in the escrow unit 44 are dropped into the returning box 19 to be stored.

After the escrow unit 44 is moved to the ejection position “b,” the opening/closing unit 58 of the hopper 51 of the holding and feeding unit 41 is opened and coins and the like in the holding and feeding unit 41 are collectively dropped into the escrow unit 44 (held coin receiving step).

After the coins and the like dropped from the holding and feeding unit 41 are collectively received in the escrow unit 44, the escrow unit 44 is moved from the ejection position “b” to the returning position “c” on the front side of the machine body 12. By this movement of the escrow unit 44, the lower surface of the escrow unit 44 is completely released from the bottom plate 76 and the bottom surface thereof is completely opened to allow the coins escrowed in the escrow unit 44 and coins dropped from the holding and feeding unit 41 to be dropped and stored in the returning box 19 (returning step).

Subsequently, the escrow unit 44 is returned to the escrow position “a” which is the regular position.

Then, the operator pulls out the returning box 19 from the machine body 12 to collect returned coins.

Moreover, as an example where the ejection and returning operation is carried out, the following cases are conceivable: a deformed coin or a foreign object which cannot be fed exists in the holding and feeding unit 41, and a feeding error that the coins cannot be fed occurs because the rotary disc 50 cannot be rotated due to too large a load or the rotary disc 50 is rotated idly caused by input of too many coins which exceeds a predetermined capacity which can be feeding-operated by the holding and feeding unit 41 at one time.

In this case, the unit is brought into a feeding error condition where, although coins are detected in the holding and feeding unit 41, coins are not detected by the recognition unit 64 for more than a predetermined period of time. When the unit is in the feeding error condition, the above-mentioned ejection and returning operation in FIG. 6(d) is carried out.

Moreover, the coin processing unit 13 can carry out counting processing operation for counting coins. In this case, operation of a counting key instead of the delivery key enables the unit to carry out the depositing operation (counting operation) in the above-mentioned FIG. 6(a) and the returning operation in FIG. 6(c), and to carry out ejection and returning operation in the above-mentioned FIG. 6(d) if the holding and feeding unit 41 is in the feeding error condition. Moreover, if there is a large amount of coins to be counted, counting operation is temporarily stopped in a case where it is detected that the escrow unit 44 is full-state, the above-mentioned returning operation in FIG. 6(c) is automatically carried out, and the returning box 19 is pulled out and reset to automatically restart the counting operation.

Thus, the stopping positions of the escrow unit 44 are set to be the following four positions: the escrow position “a” where coins to be escrowed, which are sent from the transport path 42, are received, the ejection position “b” where the coins dropped and released from the holding and feeding unit 41 are received, the returning position “c” where the escrowed coins are dropped to the returning box 19, and the storing position “d” where the escrowed coins are dropped into the coin cassette 31. Therefore, it becomes possible to move the escrow unit 44 to the ejection position “b,” and to drop and release the coins from the holding and feeding unit 41, and subsequently move the escrow unit 44 to the returning position “c” so that the coins can be collectively returned to the returning box 19. Therefore, the coin processing unit 13 of the proceeds depositing machine for a store 11 to which a large amount of coins can be deposited at one time can immediately carry out return of coins in the holding and feeding unit 41 in a case where depositing operation is cancelled or a failure in feeding coins from the holding and feeding unit 41 occurs due to input of too many coins and return of a foreign object remaining in the holding and feeding unit 41 without increasing the size of the unit, leading to improved operation efficiency.

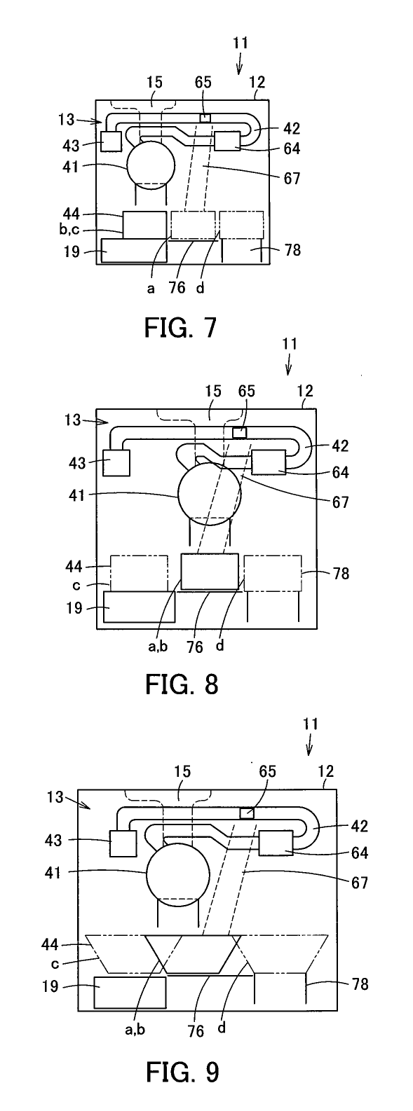

Next, another embodiment is shown in FIG. 7 which is an example where the number of stopping positions of the escrow unit 44 is three.

The holding and feeding unit 41 and the returning box 19 are vertically aligned and the returning position “c” of the escrow unit 44 is set between the holding and feeding unit 41 and the returning box 19. Therefore, the ejection position “b” and the returning position “c” in the above embodiment are in one position.

Thus, it becomes possible to set the stopping positions of the escrow unit 44 to the following three positions: the escrow position “a” where coins to be escrowed, which are sent from the transport path 42, are received, the returning position “c” where the coins dropped and released from the holding and feeding unit 41 are received and dropped into the returning box 19, and the storing position “d” where the escrowed coins are dropped into the coin cassette 31.

In this case, coins are dropped and released from the holding and feeding unit 41 in a condition where the escrow unit 44 is positioned in the returning position “c,” so that the coins can be collectively returned to the returning box 19 without moving the escrow unit 44. Therefore, the coin processing unit 13 of the proceeds depositing machine for a store 11 to which a large amount of coins can be deposited at one time can immediately carry out return of coins in the holding and feeding unit in a case where depositing process is cancelled or a failure in feeding coins from the holding and feeding unit 41 occurs due to input of too many coins and return of a foreign object remaining in the holding and feeding unit 41 without increasing the size of the unit, leading to improved operation efficiency.

Next, a further embodiment is shown in FIG. 8 which is another example where the number of stopping positions of the escrow unit is three.

The escrow position “a” of the escrow unit 44 is set below the holding and feeding unit 41 and the holding and feeding unit 41 and the chute for escrow 67 are aligned in the width direction of the machine body 12, so that coins from both the holding and feeding unit 41 and the chute for escrow 67 can be received by the escrow unit 44 in the escrow position “a” of the escrow unit 44. Therefore, the escrow position “a” and the ejection position “b” in the above embodiments are in one position.

Thus, it becomes possible to set the stopping positions of the escrow unit 44 to the following three positions: the escrow position “a” where coins to be escrowed, which are sent from the transport path 42, and coins which are dropped and released from the holding and feeding unit 41 are received, the returning position “c” where the coins escrowed are dropped into the returning box 19, and the storing position “d” where the escrowed coins are dropped into the coin cassette 31.

In this case, coins are dropped and released from the holding and feeding unit 41 in a condition where the escrow unit 44 is positioned in the escrow position “a” and subsequently the escrow unit 44 is moved to the returning position “c” so that the coins can be collectively returned to the returning box 19. Therefore, the coin processing unit 13 of the proceeds depositing machine for a store 11 to which a large amount of coins can be deposited at one time can immediately carry out return of coins in the holding and feeding unit in a case where depositing process is cancelled or a failure in feeding coins from the holding and feeding unit 41 occurs due to input of too many coins and return of a foreign object remaining in the holding and feeding unit 41 without increasing the size of the unit, leading to improved operation efficiency.

Moreover, width of the coin processing unit 13 becomes larger since the holding and feeding unit 41 and the chute for escrow 67 are aligned in the width direction of the machine body 12. However, because coins diverted one by one from the transport path 42 are dropped in the chute for escrow 67, width of the chute can be reduced compared to the one used in a case where the loose coins are collectively received and dropped. Therefore, increase in width can be suppressed.

Next, an embodiment is shown in FIG. 9 which is another example where the number of stopping positions of the escrow unit 44 is three.

Dimension of the upper surface opening, where coins are received, of the escrow unit 44 is enlarged in the depth direction of the machine body 12, the holding and feeding unit 41 and the chute for escrow 67 are aligned in the depth direction of the machine body 12, and the coins from both the holding and feeding unit 41 and the chute for escrow 67 can be received by the escrow unit 44 in the escrow position “a” of the escrow unit 44. Therefore, the escrow position “a” and the ejection position “b” in the above embodiments are in one position.

Thus, it becomes possible to set the stopping positions of the escrow unit 44 to the following three positions: the escrow position “a” where coins to be escrowed, which are sent from the transport path 42, and coins which are dropped and released from the holding and feeding unit 41 are received, the returning position “c” where the coins escrowed are dropped into the returning box 19, and the storing position “d” where the escrowed coins are dropped into the coin cassette 31.

In this case also, coins are dropped and released from the holding and feeding unit 41 in a condition where the escrow unit 44 is positioned in the escrow position “a” and subsequently the escrow unit 44 is moved to the returning position “c” so that the coins can be collectively returned to the returning box 19. Therefore, the coin processing unit 13 of the proceeds depositing machine for a store 11 to which a large amount of coins can be deposited at one time can immediately carry out return of coins in the holding and feeding unit in a case where depositing process is cancelled or a failure in feeding coins from the holding and feeding unit 41 occurs due to input of too many coins and return of a foreign object remaining in the holding and feeding unit 41 without increasing the size of the unit, leading to improved operation efficiency.

Here, in each of the above-mentioned embodiments, the bottom plate 76 may be enabled to move in the depth direction of the machine body 12 to realize each of the positions “a” to “d” of the escrow unit 44 by relative movement of the escrow unit 44 and the bottom plate 76.

Moreover, the example where any two of the escrow position “a,” the ejection position “b,” the returning position “c,” and the storing position “d” are in the same position to set number the stopping positions of the escrow unit 44 three may include examples where the escrow position “a” and the returning position “c” are in the same position, the escrow position “a” and the storing position “d” are in the same position, the returning position “c” and the storing position “d” are in the same position, as well as the examples where the ejection position “b” and the returning position “c” are in the same position and the escrow position “a” and the ejection position “b” are in the same position, as in each of the above-mentioned embodiments. In a case where the returning position “c” and the storing position “d” are in the same position, coins dropped from the escrow unit 44 in that position may be diverged by a diverting unit or the like to the returning side and storage side.

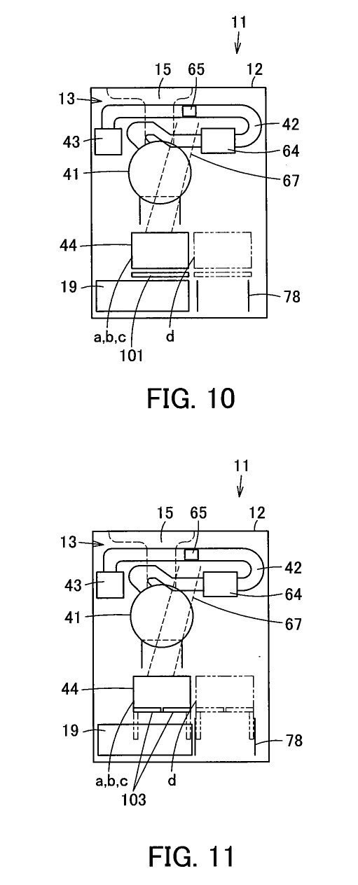

Next, a further embodiment is shown in FIG. 10 which is an example where the number of stopping positions of the escrow unit 44 is two.

The holding and feeding unit 41 and the returning box 19 are aligned vertically and the escrow position “a” of the escrow unit 44 is set between the holding and feeding unit 41 and the returning box 19. Then, in the escrow position “a” of the escrow unit 44, the holding and feeding unit 41 and the chute for escrow 67 are aligned in the width direction of the machine body 12 so that coins from both the holding and feeding unit 41 and the chute for escrow 67 can be received by the escrow unit 44. Therefore, the escrow position “a,” the ejection position “b,” and the returning position “c” in the above embodiments are in one position. The storing position “d” of the escrow unit 44 is above the coin cassette 31 and the chute for storage 78. Moreover, the returning box 19 and the chute for storage 78 are positioned next to each other so that the dimension in the depth direction of the machine body 12 becomes smaller than that in the above embodiments.

Below the escrow unit 44, a movable bottom plate 101 which can open and close the bottom surface of the escrow unit 44 is provided. The movable bottom plate 101 is provided between the escrow position “a” and the storing position “d” of the escrow unit 44 and is enabled to move by a movable bottom plate driving unit (not shown) along the moving direction of the escrow unit 44.

Thus, it becomes possible to set the moving positions of the escrow unit 44 to the following two positions: the escrow position “a” where coins to be escrowed, which are sent from the transport path 42, can be received, coins dropped and released from the holding and feeding unit 41 can be received, and the received coins can be dropped into the returning box 19, and the storing position “d” where the escrowed coins are dropped into the coin cassette 31.

In this case also, the escrow unit 44 is positioned in the escrow position “a.” In a condition where the bottom surface of the escrow unit 44 is closed by the movable bottom plate 101, coins are dropped and released from the holding and feeding unit 41 to be received by the escrow unit 44. Then, the movable bottom plate 101 is opened and moved to open the bottom surface of the escrow unit 44 so that the coins received by the escrow unit 44 are collectively returned to the returning box 19. Here, when the coins are dropped and released from the holding and feeding unit 41, the movable bottom plate 101 may be moved in advance.

Moreover, in a case where the coins escrowed in the escrow unit 44 are stored, the escrow unit 44 and the movable bottom plate 101 are moved above the chute for storage 78 and then the movable bottom plate 101 is opened and moved to open the bottom surface of the escrow unit 44 or the escrow unit 44 alone is moved above the chute for storage 78 and then the bottom surface of the escrow unit 44 is opened so that the coins escrowed in the escrow unit 44 can be stored in the coin cassette 31 through the chute for storage 78.

According to this structure, the number of moving positions of the escrow unit 44 is two. Therefore, it becomes possible to reduce the size of the machine body 12 in the depth direction.

Next, another embodiment is shown in FIG. 11 which is an example where the number of stopping positions of the escrow unit 44 is two, similar to the embodiment shown in FIG. 10.

Instead of the movable bottom plate 101 in the structure of the embodiment shown in FIG. 10, a bottom surface shutter 103 for opening and closing the bottom surface of the escrow unit 44 is provided to the bottom part of the escrow unit 44. The bottom surface shutter 103 is a double door that opens downward and is open/close driven by a bottom surface shutter driving unit (not shown).

In this case also, the escrow unit 44 is positioned in the escrow position “a.” In a condition where the bottom surface of the escrow unit 44 is closed by the bottom surface shutter 103, coins are dropped and released from the holding and feeding unit 41 to be received by the escrow unit 44. Then, the bottom surface shutter 103 is opened and moved to open the bottom surface of the escrow unit 44 so that the coins received by the escrow unit 44 are collectively returned to the returning box 19.

Moreover, in a case where the coins escrowed in the escrow unit 44 are stored, the escrow unit 44 may be moved above the chute for storage 78 and then the bottom surface shutter 103 may be opened and moved to open the bottom surface of the escrow unit 44 so that the coins escrowed in the escrow unit 44 can be stored in the coin cassette 31 through the chute for storage 78.

According to this structure, the number of moving positions of the escrow unit 44 is two. Therefore, it becomes possible to reduce the size of the machine body 12 in the depth direction.

Here, the example where any three of the escrow position “a,” the ejection position “b,” the returning position “c,” and the storing position “d” are in the same position to set the number of stopping positions of the escrow unit 44 as two may include an example where the escrow position “a,” the ejection position “b,” and the storing position “d” are in the same position as well as the example shown in the above-mentioned fifth and sixth embodiments where the escrow position “a,” the ejection position “b,” and the returning position “c” are in the same position. In each of these examples, the movable bottom plate 101 or the bottom surface shutter 103 may be used for the escrow unit 44. Moreover, in a case where the returning position “c” and the storing position “d” are in the same position, coins dropped from the escrow unit 44 in that position may be diverted by a diverting unit or the like to the returning side and storage side.

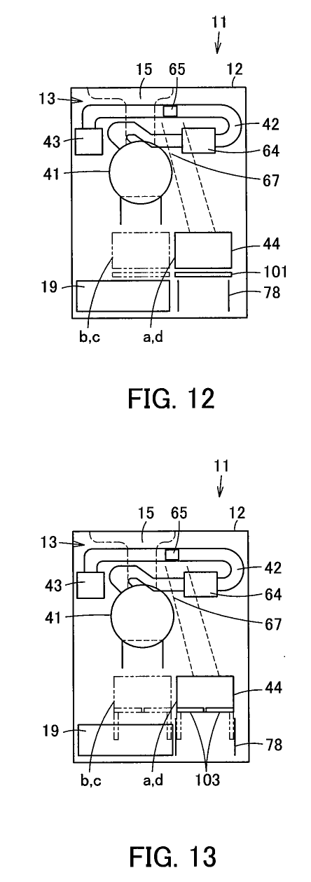

Next, a further embodiment is shown in FIG. 12 which is another example where the number of stopping positions of the escrow unit 44 is two.

The escrow position “a” of the escrow unit 44 is set above the chute for storage 78 of the coin cassette 31 and coins from the chute for escrow 67 can be received by the escrow unit 44 in the escrow position “a” of the escrow unit 44. Therefore, the escrow position “a” and the storing position “d” in the above embodiments are in one position.

The holding and feeding unit 41 and the returning box 19 are vertically aligned and the returning position “c” of the escrow unit 44 is set between the holding and feeding unit 41 and the returning box 19. Coins dropped and released from the holding and feeding unit 41 can be received in the returning position “c” of the escrow unit 44. Therefore, the returning position “c” and the ejection position “b” in the first embodiment are in one position.

Moreover, the returning box 19 and the chute for storage 78 are positioned next to each other so that the dimension in the depth direction of the machine body 12 becomes smaller than that in the above embodiments.

Below the escrow unit 44, a movable bottom plate 101 which can open and close the bottom surface of the escrow unit 44 is provided. The movable bottom plate 101 is enabled to move between the escrow position “a” and the returning position “c” of the escrow unit 44 by a movable bottom plate driving unit (not shown) along the moving direction of the escrow unit 44.

Thus, it becomes possible to set the stopping positions of the escrow unit 44 to the following two positions: the escrow position “a” where coins to be escrowed, which are sent from the transport path 42, can be received, coins dropped and released from the holding and feeding unit 41 can be received, and the received coins can be dropped into the returning box 19, and the storing position “d” where the escrowed coins are dropped into the coin cassette 31.

In this case, the escrow unit 44 is positioned in the escrow position “a.” In a condition where the bottom surface of the escrow unit 44 is closed by the movable bottom plate 101, coins dropped and released from the chute for escrow 67 are escrowed in the escrow unit 44. When the coins escrowed in the escrow unit 44 are stored, the movable bottom plate 101 is opened and moved to open the bottom surface of the escrow unit 44 so that the coins escrowed in the escrow unit 44 can be stored in the coin cassette 31 through the chute for storage 78.

Moreover, in a case where coins in the holding and feeding unit 41 are returned, the escrow unit 44 positioned in the escrow position “a” is moved to the returning position “c” with the movable bottom plate 101 for closing the bottom surface of the escrow unit 44 and subsequently the coins are dropped and released from the holding and feeding unit 41 to be received by the escrow unit 44. Then, the movable bottom plate 101 is opened and moved to open the bottom surface of the escrow unit 44 so that the coins received in the escrow unit 44 are collectively returned to the returning box 19. Here, when the coins are dropped and released from the holding and feeding unit 41, the movable bottom plate 101 may be opened and moved in advance.

According to this structure, the number of moving positions of the escrow unit 44 is two. Therefore, it becomes possible to reduce the size of the machine body 12 in the depth direction.

Next, an embodiment is shown in FIG. 13 which is an example where the number of stopping positions of the escrow unit 44 is two, similar to the embodiment shown in FIG. 12.

Instead of the movable bottom plate 101 in the structure of the embodiment shown in FIG. 12, a bottom surface shutter 103 for opening and closing the bottom surface of the escrow unit 44 is provided to the bottom part of the escrow unit 44. The bottom surface shutter 103 is a double door that opens downward and is open/close driven by a bottom surface shutter driving unit (not shown).

In this case also, the escrow unit 44 is positioned in the escrow position “a.” In a condition where the bottom surface of the escrow unit 44 is closed by the bottom surface shutter 103, coins dropped and released from the chute for escrow 67 are escrowed in the escrow unit 44. When the coins escrowed in the escrow unit 44 are stored, the bottom surface shutter 103 is opened and moved to open the bottom surface of the escrow unit 44. Thus, it becomes possible to store the coins escrowed in the escrow unit 44 into the coin cassette 31 through the chute for storage 78.

Moreover, in a case where coins in the holding and feeding unit 41 are returned, the escrow unit 44 positioned in the escrow position “a” is moved to the returning position “c” and subsequently the coins are dropped and released from the holding and feeding unit 41 to be received by the escrow unit 44. Then, the bottom surface shutter 103 is opened and moved to open the bottom surface of the escrow unit 44 so that the coins received in the escrow unit 44 are collectively returned to the returning box 19. Here, when the coins are dropped and released from the holding and feeding unit 41, the bottom surface shutter may be opened and moved in advance.

According to this structure, the number of moving positions of the escrow unit 44 is two. Therefore, it becomes possible to reduce the size of the machine body 12 in the depth direction.

Here, the example where any two of the escrow position “a,” the ejection position “b,” the returning position “c,” and the storing position “d” are in the same position while the remaining two positions are also in the same position to set the number of stopping positions of the escrow unit 44 to two may include an example where the escrow position “a” and the returning position “c” are in the same position while the ejection position “b” and the storing position “d” are in the same position, as well as the example where the ejection position “b” and the returning position “c” are in the same position while the escrow position “a” and the storing position “d” are in the same position as in the above-mentioned embodiments. In each of these examples, the movable bottom plate 101 or the bottom surface shutter 103 may be used for the escrow unit 44. Moreover, in a case where the returning position “c” and the storing position “d” are in the same position, coins dropped from the escrow unit 44 in that position may be diverted by a diverting unit or the like to the returning side and storage side.

The present invention is used for a coin processing unit such as a proceeds depositing machine for a store.

1. A coin processing method for processing coins comprising the steps of:
a holding and feeding step receiving and holding coins input from a coin inlet into a holding and feeding unit and for feeding the coins thus held by the holding and feeding unit to a transport path one by one;
a recognition and diversion step transporting and recognizing coins which are fed from the holding and feeding unit to the transport path one by one and for diverting the coins on the basis of the recognition result to respective transportation destinations;
an escrow step escrowing the coins diverted from the transport path in an escrow unit;
a storage step storing the coins in the escrow unit in a coin storing unit when the input coins are stored after the temporary retention;
a held coin receiving step causing a lower part of the holding and feeding unit to be opened so that the coins in the holding and feeding unit are dropped and released and for receiving the coins thus dropped and released from the holding and feeding unit in the escrow unit when coins in the holding and feeding unit are returned; and
a returning step collectively returning the coins thus received in the escrow unit to a coin returning unit.

2. The coin processing method according to claim 1, wherein
the escrow step further comprises the step of moving the escrow unit to an escrow position where coins diverted from the transport path are received,
wherein the storage step further comprises the step of moving the escrow unit to a storing position and dropping the escrowed coins into the coin storing unit,
wherein the held coin receiving step further comprises the step of moving the escrow unit to an ejection position where the coins dropped and released from the holding and feeding unit are received, and
wherein the returning step further comprises the step of moving the escrow unit to a returning position and dropping the escrowed coins into the coin returning unit.

3. The coin processing method according to claim 1, wherein
any of two positions among the escrow position where the escrow unit receives the coins diverted from the transport path, the ejection position where the coins dropped and released from the holding and feeding unit are received by the escrow unit, the returning position where the coins escrowed in the escrow unit are dropped to the coin returning unit, and the storing position where the coins escrowed in the escrow unit are dropped to the coin storing unit, are in the same position, and
in each of the escrow step, storage step, held coin receiving step, and returning step, the escrow unit is moved to the positions corresponding to each of the steps.

4. The coin processing method according to claim 1, wherein
any of three positions among the escrow position where the escrow unit receives the coins diverted from the transport path, the ejection position where the coins dropped and released from the holding and feeding unit are received by the escrow unit, the returning position where the coins escrowed in the escrow unit are dropped to the coin returning unit, and the storing position where the coins escrowed in the escrow unit are dropped to the coin storing unit, are in the same position, and
in each of the escrow step, storage step, held coin receiving step, and returning step, the escrow unit is moved to the positions corresponding to each of the steps.

5. The coin processing method according to claim 1, wherein
any of two positions and remaining two positions among the escrow position where the escrow unit receives the coins diverted from the transport path, the ejection position where the coins dropped and released from the holding and feeding-unit are received by the escrow unit, the returning position where the coins escrowed in the escrow unit are dropped to the coin returning unit, and the storing position where the coins escrowed in the escrow unit are dropped to the coin storing unit, respectively are in the same positions, and
in each of the escrow step, storage step, held coin receiving step, and returning step, the escrow unit is moved to the positions corresponding to each of the steps.

6. A coin processing unit for processing coins comprising:
a holding and feeding unit receiving and holding coins input from a coin inlet, feeding the coins one by one, and opening a lower part of the unit so that the coins can be dropped and released;
a transport path transporting the coins fed from the holding and feeding unit one by one, recognizing the coins under transportation by way of a recognition unit provided in the middle of the transport passage of the coins, and diverting the coins by destinations on the basis of the recognition result;
an escrow unit escrowing the coins diverted from the transport path;
a coin storing unit storing the coins which are escrowed in the escrow unit;
a coin returning unit returning the coins escrowed in the escrow unit and coins held in the holding and feeding unit;
a driving unit moving the escrow unit to an escrow position where the coins diverted from the transport path to be escrowed are received, an ejection position where the coins dropped and released from the holding and feeding unit are received, a returning position where the escrowed coins are dropped to the coin returning unit, and a storing position where the escrowed coins are dropped to the coin storing unit; and
a control unit which moves the escrow unit to the ejection position so that the coins can be dropped and released from the holding and feeding unit and subsequently moves the escrow unit to the returning position so that the coins can be dropped to the coin returning unit.

7. A coin processing unit for processing coins comprising:
a holding and feeding unit receiving and holding coins input from a coin inlet, feeding the coins one by one, and opening a lower part of the unit so that the coins can be dropped and released;
a transport path transporting the coins fed from the holding and feeding unit one by one, recognizing the coins under transportation by way of a recognition unit provided in the middle of the transport passage of the coins, and diverting the coins by destinations on the basis of the recognition result;
an escrow unit escrowing the coins diverted from the transport path;
a coin storing unit storing the coins which are escrowed in the escrow unit;
a coin returning unit returning the coins escrowed in the escrow unit and coins held in the holding and feeding unit;
a driving unit moving the escrow unit to an escrow position where the coins diverted from the transport path to be escrowed are received by the escrow unit, an ejection position where the coins dropped and released from the holding and feeding unit are received by the escrow unit, a returning position where the coins escrowed in the escrow unit are dropped to the coin returning unit, and a storing position where the coins escrowed in the escrow unit are dropped to the coin storing unit, wherein any two of the positions are in the same position; and
a control unit dropping and dispensing the coins in the holding and feeding unit to the escrow unit and for dropping the coins from the escrow unit to the coin returning unit.

8. A coin processing unit for processing coins comprising:
a holding and feeding unit receiving and holding coins input from a coin inlet, feeding the coins one by one, and opening a lower part of the unit so that the coins can be dropped and released;
a transport path transporting the coins fed from the holding and feeding unit one by one, recognizing the coins under transportation by way of a recognition unit provided in the middle of the transport passage of the coins, and diverting the coins by destinations on the basis of the recognition result;
an escrow unit escrowing the coins diverted from the transport path to be escrowed;
a coin storing unit storing the coins which are escrowed in the escrow unit;
a coin returning unit returning the coins escrowed in the escrow unit and coins held in the holding and feeding unit;
a driving unit moving the escrow unit to an escrow position where the coins diverted from the transport path to be escrowed are received by the escrow unit, an ejection position where the coins dropped and released from the holding and feeding unit are received by the escrow unit, a returning position where the coins escrowed in the escrow unit are dropped to the coin returning unit, and a storing position where the coins escrowed by the escrow unit are dropped to the coin storing unit, wherein any three of the positions are in the same position; and
a control unit dropping and dispensing the coins in the holding and feeding unit to the escrow unit and for dropping the coins from the escrow unit to the coin returning unit.

9. A coin processing unit for processing coins comprising:
a holding and feeding unit receiving and holding coins input from a coin inlet, feeding the coins one by one, and opening a lower part of the unit so that the coins can be dropped and released;
a transport path transporting the coins fed from the holding and feeding unit one by one, recognizing the coins under transportation by way of a recognition unit provided in the middle of the transport passage of the coins, and diverting the coins by destinations on the basis of the recognition result;
an escrow unit escrowing the coins diverted from the transport path;
a coin storing unit storing the coins which are escrowed in the escrow unit;
a coin returning unit returning the coins escrowed in the escrow unit and coins held in the holding and feeding unit;
a driving unit moving the escrow unit to an escrow position where the coins diverted from the transport path to be escrowed are received by the escrow unit, an ejection position where the coins dropped and released from the holding and feeding unit are received by the escrow unit, a returning position where the coins escrowed in the escrow unit are dropped to the coin returning unit, and a storing position where the coins escrowed in the escrow unit are dropped to the coin storing unit, wherein any two of the positions are in the same position while remaining two positions are also in the same position; and
a control unit dropping and dispensing the coins in the holding and feeding unit to the escrow unit and for dropping the coins from the escrow unit to the coin returning unit.

10. The coin processing unit according to claim 7, wherein a movable bottom plate, which can open and close a bottom surface of the escrow unit, is provided movably along the moving direction of the escrow unit.

11. The coin processing unit according to claim 7, wherein a bottom surface shutter for opening and closing a bottom surface of the escrow unit is provided to the escrow unit.

12. The coin processing unit according to claim 8, wherein a movable bottom plate, which can open and close a bottom surface of the escrow unit, is provided movably along the moving direction of the escrow unit.

13. The coin processing unit according to claim 9, wherein a movable bottom plate, which can open and close a bottom surface of the escrow unit, is provided movably along the moving direction of the escrow unit.

14. The coin processing unit according to claim 8, wherein a bottom surface shutter for opening and closing a bottom surface of the escrow unit is provided to the escrow unit.

15. The coin processing unit according to claim 9, wherein a bottom surface shutter for opening and closing a bottom surface of the escrow unit is provided to the escrow unit.
